(19) United States
(12) Patent Application Publication
(10) Pub. No.: US 2013/0049317 A1
(43) Pub. Date: Feb. 28, 2013

(54) Skateboard for simulation of long board surfing

(71) Applicant: Christopher J. Cheek, Santa Cruz, CA (US)

(72) Inventor: Christopher J. Cheek, Santa Cruz, CA (US)

(21) Appl. No.: 13/199,180

(22) Filed: Aug. 22, 2011

(51) Int. Cl. B62M 1/00

(52) U.S. Cl. 280/87.042

(57) ABSTRACT

A skateboard that simulates the feel and ride of a long board surfboard, comprising: an elongated deck, having a flat front section, a convex central portion, and a flat rear section which is elevated. A front truck assembly is secured to the flat front section of the elongated deck. A wheel block is mounted adjacent to the convex central portion of the elongated deck, and a large wheel is operably secured within the wheel block. A rear truck assembly is secured to the elevated flat rear section of the elongated deck, the rear truck assembly being elevated above the convex central portion of the elongated deck, thereby allowing the skateboard to be balanced by the front truck assembly and the wheel unless the skateboard is turned abruptly to the left or right.

### BACKGROUND OF THE INVENTION

1. Technical Field

This invention relates to skateboards, and more particularly to a skateboard which uses a single bicycle-type wheel centrally mounted to a rear portion of the skateboard, to simulate the feel of an actual long board surfboard without a wave.

2. Background Art

Various skateboards have been proposed and implemented for sport and recreational purposes. Although prior skateboards have been adapted and used for various purposes, there have not been developments in the skateboard field that allow a user to mimic and simulate the feel of a long board surfboard. Accordingly, the present invention shares very little with existing skateboards, and has a completely different look and feel when in use.

Today's skateboards are either designed for high performance tricks, such as the short skateboard, or they are designed for cruising on, such as the long board skateboard. Skateboards are not designed for cross stepping as done when ocean surfing, as they lack stability. It is possible to cross step on a long board skateboard, but the feeling and experience is nothing like real surfing.

The present invention, provides, for the first time, a skateboard that feels, when used, just like surfing a long board surfboard. This is due to a variety of novel features of the present invention, primarily the length of the board in conjunction with a large rear wheel creates this surfing sensation. The rear wheel and wheel block act as a counterbalance as the user moves further onto the nose or the board, allowing for a “nose ride”. Further, the skateboard of the present invention is designed so as to provide a counterweight allowing the user to “hang ten’, which is when the rider hangs all ten of his or her toes over the nose of the board. This is something that a conventional skateboard is far too unstable to do, but is done with ease on the skateboard of the present invention.

The skateboard of the present invention also possesses the ability to handle excessive speed as encountered when traveling down a large steep hill. The stability of the large rear wheel as well as its diameter, allows the user to increase speed exponentially as momentum is gained. Conventional skateboards tend to become highly unstable at high speeds due to the confines of the truck and skateboard wheels

The skateboard of the present invention is configured to be highly stable at high speed, and the large rear wheel is capable of handling far more speed than a typical skateboard wheel by itself, and by combining the two, a far greater stability is obtained. Further, a conventional skateboard feels as if it is on tracks due to the placement of the four wheels on skateboard trucks.

The present invention provides a unique skateboard that closely mimics the balance and center of gravity a user would experience when surfing in the ocean on a long board surfboard. The skateboard of the present invention allows a user who for some reason or another is unable to go to the beach and ride a wave, the ability to learn or keep in practice by using this board as a method of cross training. The applicant is not aware of any other skateboard construction or design that so closely replicates this sensation of riding a wave.

Accordingly, the primary object of the present invention is to provide a skateboard to simulate the feel of an actual long board surfboard without a wave. The skateboard of the present invention may be easily adapted for use, is easy to learn how to use, is very reliable, and is very efficient in operation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF SUMMARY OF THE INVENTION

To achieve the foregoing objects, and in accordance with the purpose of the invention as embodied and broadly described herein, a skateboard that simulates the feel and ride of a long board surfboard is provided, comprising: an elongated deck, having a flat front section, a convex central portion, and a flat rear section which is elevated. A front wheel truck assembly is secured to the flat front section of the elongated deck. A wheel block is mounted adjacent to the convex central portion of the elongated deck, and a large bicycle type wheel is operably secured within the wheel block. A rear wheel truck assembly is secured to the elevated flat rear section of the elongated deck, with the rear truck assembly being elevated above the convex central portion of the elongated deck, thereby allowing the skateboard to be balanced by the front wheel truck assembly and the wheel unless the skateboard is turned abruptly to the left or right. Accordingly, the present provides a stable three-point axis for the skateboard which converts to a four-point axis when turned to the left or right, and provides a ride remarkably similar to that of riding a long board surfboard on a wave.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a skateboard for simulation of long board surfing, according to the invention.

FIG. 2 shows a top view of a skateboard for simulation of long board surfing, according to the invention.

FIG. 3, shows a view of the skateboard deck construction, of a skateboard for simulation of long board surfing, according to the invention.

FIG. 4 shows a cut-away view of the convex portion of the deck of a skateboard for simulation of long board surfing, according to the invention.

FIG. 5 is an end view of the back wheels prior to turning the skateboard for simulation of long board surfing, according to the invention.

FIG. 6, shows an end view of rear wheels with left rear wheel engaging when the skateboard for simulation of long board surfing is turned to the left, according to the invention.

FIG. 7 is an end view of rear wheels with right rear wheel engaging when the skateboard for simulation of long board surfing is turned to the right, according to the invention.

### DETAILED DESCRIPTION OF THE INVENTION

Reference will now be made in detail to the present preferred embodiments of the invention as illustrated in the accompanying drawings.

In accordance with the present invention, there is provided in a preferred embodiment of the invention, a skateboard that simulates the feel and ride of a long board surfboard, comprising, an elongated deck, having a flat front section, a convex central portion, and a flat rear section; a front wheel truck assembly, the front wheel truck assembly being secured to the flat front section of the elongated deck; a wheel block, mounted adjacent to the convex central portion of the elongated deck; a wheel operably secured within the wheel block; and a rear wheel truck assembly secured to the flat rear section of the elongated deck. The rear wheel truck assembly is elevated above the convex central portion of the elongated deck, thereby allowing the skateboard to be balanced by the front wheel truck assembly and the wheel unless the skateboard is turned abruptly to the left or right.

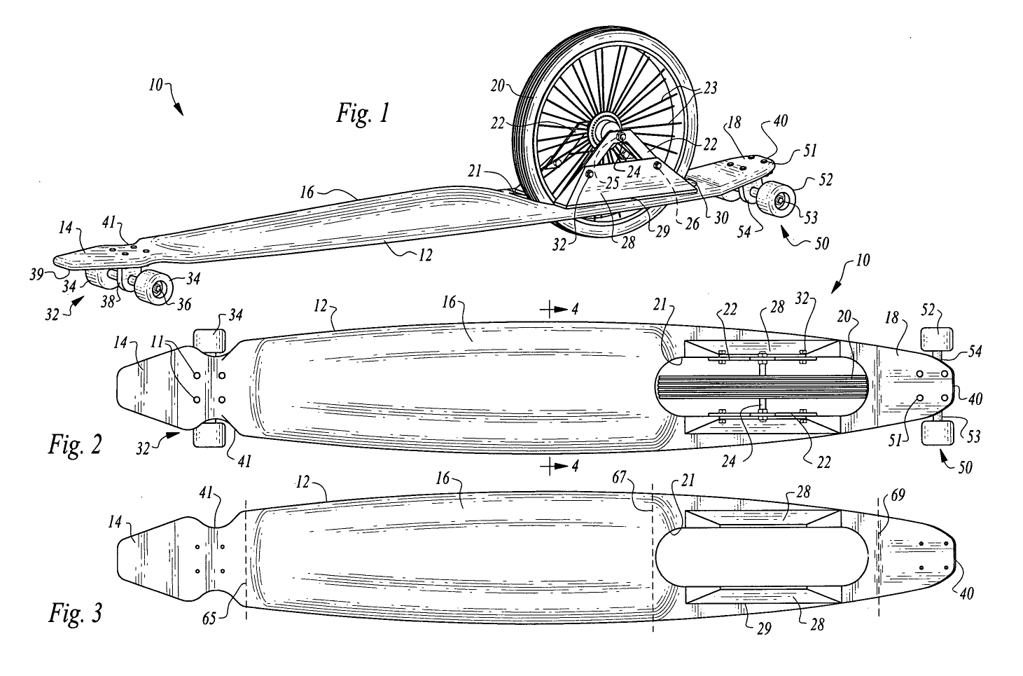

In FIG. 1, a preferred embodiment of a skateboard 10, that simulates the feel and ride of a long board surfboard, is shown. Preferably, skateboard 10, has elongated deck 12, having a flat front section 14, a convex central portion 16, and a flat rear section 18. In a preferred embodiment, elongated deck 12, is approximately ¾ inches thick in flat front section 14, and the deck 12, preferably composed of three layers of ¼ inch 3 ply bamboo or hardwood laminated together. Of course, the deck may be provided in different thickness and composed of different materials, for example either thicker or thinner, or made of any durable resilient material, such as wood, composite, foam, plastic, or metal, and layered or not. In a preferred embodiment the entire deck 12, length is approximately 6 feet, with the front flat section 14 about 7 inches. In other embodiments deck 12, may be provided in longer or shorter lengths, and flat front section 14, be greater or less than 7 inches.

The central convex portion 16, begins after front flat section 14, and is preferably made increasingly convex up to where rear wheel 20, is mounted. This convex construction is to simulate the feel of a surfboard deck beneath the user's feet. Although convex portion 16, has been described as being ever more convex as it nears wheel 20, embodiments may be provided where this is not the case, and a more uniform curvature throughout the convex portion is provided. This is a matter of what type of surfboard ride and feel is being simulated in a particular embodiment.

A flat rear section 18, of deck 12, is also seen in FIG. 1. This section of deck 12, is seen extending from a wheel mount 28, for wheel 20, to the end of deck 12. From the end of wheel cutout 30, for wheel 20, the deck angles upward as shown, so that the flat rear section 18, is elevated above convex section 16, of deck 12. Preferably, the flat rear section 18, angles up approximately 1¼ inch rise, and is approximately 12 inches from wheel cutout 30, to deck end 40. These dimensions are provided only as an example of a preferred embodiment, and other sizes and dimensions may be used in different configurations and embodiments. The critical feature is the elevated flat rear section 18, which will hold rear wheel truck assembly 50, with wheels 52, off the ground unless the skateboard is turned to the left or to the right.

In FIG. 1, a front wheel truck assembly, 32, includes wheels 34, axle 36, and truck mount assembly 38, is secured to the underside 39, of flat front section 14, of deck 12, by bolts 11, screws, nuts, or other mechanical fastening means seen in FIG. 2. Preferably, flat front section 14, of deck 12, includes a wheel cutout 41, on both sides of deck 12, which is preferably crescent shaped, but may be otherwise. Wheel cutout 41, allows skateboard 10, to lean drastically to one side or the other without the wheels 34, contacting the deck 12, which would cause the wheels to abruptly stop.

Deck 12, of skateboard 10, is preferably constructed from layers of bamboo veneer. In a preferred embodiment nine layers are used, but of course, differing models may use different number of layers. The veneer is preferably laminated together to a thickness of about ¾ of an inch, but may be thicker or thinner depending on the model and the desired “feel” of the skateboard. Hardwood veneers may also be used, or other durable resilient material such as composites may be substituted.

Wheel block 28, which hold rear wheel 20, is preferably constructed out of laminated veneer, either bamboo or hardwood, and is preferably about two inches in height. Wheel block 28, is preferably positioned adjacent to convex central portion 16, of deck 12. Wheel block 28, is preferably laminated directly to the deck 12, and is where mounting brackets 22, are attached for securing rear wheel 20. Preferably, two mounting brackets 22, are used, one on each side of wheel 20, and may be secured by nuts, screws, bolts or other mechanical means well known in the art. Wheel block 28, is configured to surround aperture 21, in deck 12, in which wheel 20, is positioned, and preferably has a flat surface 29, and secured to deck 12, by bolts 32, nuts, screws, or other mechanical fasteners, or by adhesives.

Wheel 20, positioned in wheel block 28, and aperture 21, is preferably a 16 inch bicycle type wheel, with spokes 23. Different size and types wheels may be used in different embodiments, either larger or smaller, with or without spokes. Wheel axle 24, is positioned in mounting bracket 22, in aperture 25, and mounting bracket 22, secured by bolts, nuts, screws or the like, in aperture 26, to mounting block 28. The use of wheel 20, and front wheel assembly 32, with wheels 34, create a three point axis. This axis is what centers the user's weight over wheel 20, simulating the balance and feel of riding a long board surfboard. Aperture 25, in a preferred embodiment of the invention is approximately 17 inches in length and about 3⅝ inches wide. Of course, these dimensions would vary if different wheel sizes are used, however, this is a preferred size when a 16 inch wheel is used. Wheel block 28, also serves to limit the amount of flex and bend on mounting brackets 22, which occur when skateboard 10, is turned, and provide wheel 20, a solid mounting base.

As seen in FIG. 1, at the end of deck 16, just past the end wheel 20, flat deck end 18, begins to angle upwards to end 40, of flat deck section 18. Rear wheel truck assembly 50, is preferably mounted near the end 40, of flat deck section 18. Rear wheel truck assembly 50, is preferably mounted to rear deck section 18, by bolts 51, screws, nuts or other mechanical fastening means well known in the art, seen in FIG. 2. Rear wheel truck assembly 50, includes wheels 52, with axle 53, and truck mount assembly 54. Wheels 52, of rear wheel truck assembly 50, is what engages the ground as skateboard 10, is turned from side to side, left, to right, or termed “carving” in the sport. As can be seen in FIG. 1, rear wheel truck assembly 50, is mounted near the end 40, of skateboard deck 12. As the user turns skateboard 10, by leaning, rear wheel truck assembly 50, in particular wheels 52, contact the ground, this adds stability to skateboard 10, by not allowing skateboard 10, to tip over, while at the same time, pushing the end 40, or tail of the skateboard 10, in the direction required. Accordingly, rear wheel truck assembly 50, wheels 52, do not contact the ground unless the board is turning. This is shown in detail in FIGS. 5, 6, and 7.

With reference now to FIG. 2, a top view of skateboard 10, is shown, with deck 12, convex section of deck 16, and front flat section 14, and flat rear section 18. Deck cutout 41, allows the board to be leaned or turned drastically from one side to the other without wheels 34, contacting deck 12. Front wheel truck assembly 32, with wheels 32, is secured by bolts 11, or screws, or nuts, or other mechanical fastening means.

In FIG. 2, wheel 20, is seen mounted in aperture 21, by mounting brackets 22. The flat rear section 18, of deck 12, is shown with rear wheel truck assembly 50, with wheels 52, and axle 53, and being secured to rear flat section 18, by bolts 51, screws, nuts or other mechanical fastening mechanisms well known in the art.

With reference now to FIG. 3, deck 12, of skateboard 10, is shown without the front or rear wheel truck assemblies, or wheel 20, to illustrate a preferred construction of deck 12. Flat front section 14, with wheel cutouts 41, extends to point 65. Preferably flat front section 14, is about 7 inches in length for a six foot length deck. Of course, different size convex central portions may be used depending upon the total deck length, and the type and style of skateboard use and feel desired At point 65, convex central portion 16, begins and extends to point 67. For a 6 foot length deck, convex central portion 16, is preferably about 3.5 feet in length. Of course, different size convex central portions may be used depending upon the total deck length, and the type and style of skateboard, and the use and feel desired. At point 67, wheel block 28, begins and extends to point 69. Preferably wheel block 28, has flat surface 29, and is about 18.5 inches in length for a six foot length deck, with different size variations being used for different types and styles of skateboard, and the use and feel desired. At point 69, flat rear section 18, bends slightly upwards, and continues until deck end 40. A typical length of flat rear section 18, would be about 5.5 inches, for a six foot in length deck, but may of course be if different length decks are used, and for different styles, and for the use and feel desired.

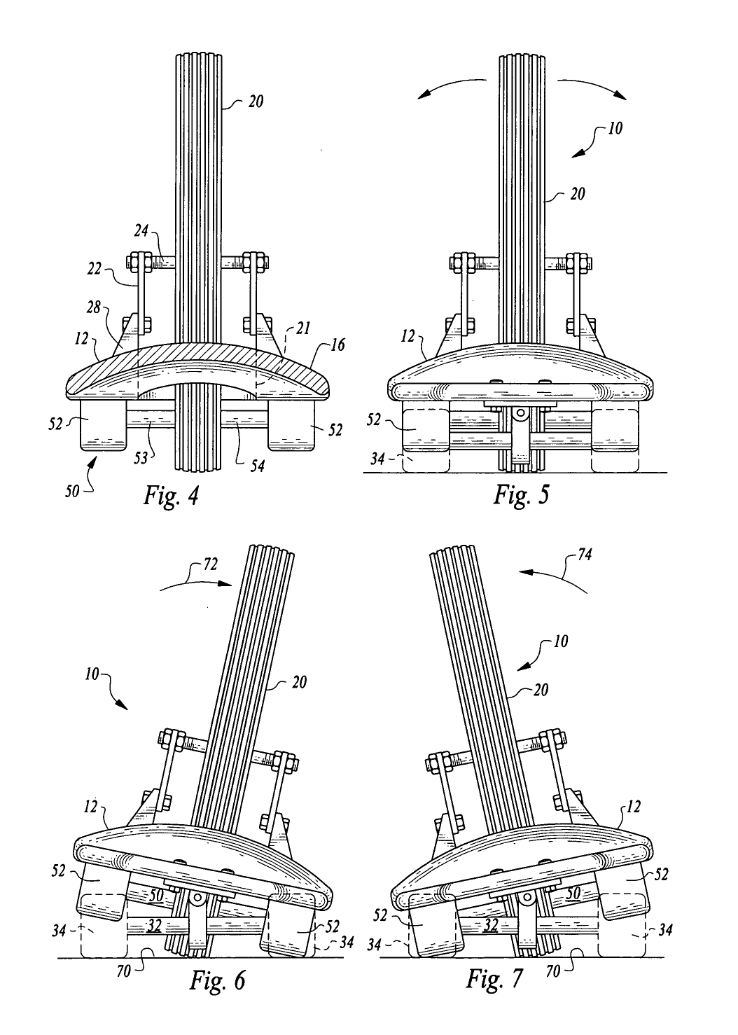

In FIG. 4, a cut-away view of convex central portion 16, of deck 12 is shown. In a preferred embodiment, convex central portion 16, is about ⅝ of an inch in thickness, however, this may vary, depending upon the material used to construct deck 12, and the feel and ride type desired.

In FIGS. 5, 6, and 7, it is illustrated how the rear wheel truck assembly of skateboard 10, engages only when weight is transferred from one side of skateboard deck 12 to the other, that is, when the user is turning skateboard 10, to either the left or to the right.

In FIG. 5, rear wheel truck assembly 50, is shown with wheels 52, off of ground 70, when skateboard 10, is going straight and is not being turned. This configuration of three wheels being on the ground and forming a three point axis, that is the two front wheels 34, of front wheel truck assembly 34, and wheel 20, when skateboard 10, is going in a straight direction, provide a very stable and comfortable ride.

In FIG. 6, rear wheel truck assembly 50, with wheel 52, now engaged to ground 70, on the left hand side, when the user turns skateboard 10, to the left as indicated by arrow 72. When this occurs, then four wheels are contacting the ground, that is the front two wheels 34, of front wheel assembly 32, wheel 20, and left wheel 52, of rear truck assembly 50.

In FIG. 7, rear wheel truck assembly 50, with wheel 52, now engaged to ground 70, on the right hand side when the user turns skateboard 10, to the right as indicated by arrow 74. When this occurs, then four wheels are contacting the ground, that is the front two wheels 34, of front wheel assembly 32, wheel 20, and right wheel 52, of rear truck assembly 50.

In operation and use, skateboard 10, of the present invention, provides, for the first time, a skateboard that feels, when used, just like surfing a long board surfboard. This is due to a variety of novel features described above, primarily the length of the board in conjunction with a large rear wheel 20, creates this surfing sensation. The rear wheel 20, and wheel block 28, act as a counterbalance as the user moves further onto the nose or the board, allowing for a “nose ride”, and create a three point axis with front wheel truck assembly 32, with wheels 34. Further, the skateboard of the present invention is designed so as to provide a counterweight allowing the user to “hang ten”, which is when the rider hangs all ten of his or her toes over the nose of the board, and convex central portion 16, of deck 12, allow the user to “cross step”, and handle and turn skateboard 10, just like a long board surfboard. This is something that a conventional skateboard is far too unstable to do, but is done with ease on the skateboard of the present invention.

The skateboard of the present invention also possesses the ability to handle excessive speed as encountered when traveling down a large steep hill. The stability of the large rear wheel 20, as well as its diameter, allows the user to increase speed exponentially as momentum is gained. Conventional skateboards tend to become highly unstable at high speeds due to the confines of the truck and skateboard wheels

Skateboard 10, of the present invention is configured to be highly stable at high speed, and the large rear wheel is capable of handling far more speed than a typical skateboard wheel by itself, and by combining the two, a far greater stability is obtained. Further, a conventional skateboard feels as if it is on tracks due to the placement of the four wheels on skateboard trucks.

The present invention provides a unique skateboard that closely mimics the balance and center of gravity a user would experience when surfing in the ocean on a long board surfboard. The skateboard of the present invention allows a user who for some reason or another is unable to go to the beach and ride a wave, the ability to learn or keep in practice by using this board as a method of cross training.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A skateboard that simulates the feel and ride of a long board surfboard, comprising:
an elongated deck, having a flat front section, a convex central portion, and a flat rear section;
a front wheel truck assembly, said front wheel truck assembly being secured to said flat front section of said elongated deck;
a wheel block, mounted adjacent to said convex central portion of said elongated deck;
a wheel operably secured within said wheel block; and
a rear wheel truck assembly secured to said flat rear section of the elongated deck, said rear wheel truck assembly being elevated above said convex central portion of said elongated deck, thereby allowing the skateboard to be balanced by said front wheel truck assembly and said wheel unless said skateboard is turned abruptly to the left or right.

2. The skateboard of claim 1, wherein said flat front section of said elongated deck includes a wheel cutout section on both sides of the elongated deck.

3. The skateboard of claim 1, wherein said wheel block has a mounting bracket secured therein for operably securing said wheel.

4. The skateboard of claim 3, wherein said wheel block comprises a series of different sheets of a durable, flexible material laminated together, to limit the amount of flex and bend on said mounting bracket.

5. The skateboard of claim 1, wherein said flat rear section of said elongated deck includes an upward elevated section, said rear truck is secured to said upward elevated section and is engaged as the skateboard is turned from side to side, as the user turns the skateboard by leaning, said back truck contacts the ground, adding stability to the skateboard by not allowing the skateboard to tip over while at the same time pushing the flat rear section of said elongate deck in the direction required.

6. The skateboard of claim 1, wherein said wheel is a 16 inch wheel.

7. The skateboard of claim 1, wherein said elongated deck is composed of a plurality of layers of bamboo veneer.

8. The skateboard of claim 1, wherein said elongated deck is composed of a plurality of layers of hardwood veneer.

9. The skateboard of claim 4, said series of different sheets of said durable, flexible material laminated together of said wheel block are composed of bamboo.

10. The skateboard of claim 1, wherein said elongated deck is 6 feet in length.

11. A skateboard that simulates the feel and ride of a long board surfboard by providing a stable three-point axis which converts to a four-point axis when turned to the left or right, comprising:
an elongated deck, having a flat front section, a convex central portion, and a flat rear section;
a front wheel truck assembly, said front wheel truck assembly being secured to said flat front section of said elongated deck;
a wheel block, mounted through said convex central portion of said elongated deck;
a wheel operably secured within said wheel block; and
a rear wheel truck assembly secured to said flat rear section of the elongated deck, said rear wheel truck assembly being elevated above convex central portion of said elongated deck, thereby forming a stable three-point support axis which converts to a four-point support axis when turned the skateboard is turned to the left or right, allowing the skateboard to be balanced by said front wheel truck assembly and said wheel unless said skateboard is turned abruptly to the left or right.

12. The skateboard of claim 11, wherein said flat front section of said elongated deck includes a crescent shaped wheel cutout section on both sides of the elongated deck.

13. The skateboard of claim 11, wherein said wheel block has a mounting bracket secured therein for operably securing said wheel by securing an axle of said wheel to said mounting bracket.

14. The skateboard of claim 11, wherein said wheel block comprises a series of different sheets of a durable, flexible material laminated together, to limit the amount of flex and bend on said mounting bracket.

15. The skateboard of claim 11, wherein said flat rear section of said elongated deck includes an upwardly elevated section, said rear wheel truck is secured to said upward elevated section and is engaged as the skateboard is turned from side to side, as the user turns the skateboard by leaning, said back truck contacts the ground, adding stability to the skateboard by not allowing the skateboard to tip over while at the same time pushing the flat rear section of said elongate deck in the direction required.

16. The skateboard of claim 11, wherein said wheel is a 16 inch wheel.

17. The skateboard of claim 11, wherein said elongated deck is composed of a plurality of layers of bamboo veneer.

18. The skateboard of claim 11, wherein said elongated deck is composed of a plurality of layers of hardwood veneer.

19. A skateboard that simulates the feel and ride of a long board surfboard, comprising:
an elongated deck;
a front wheel truck assembly, said front wheel truck assembly being secured to said elongated deck;
a wheel block, said wheel block being mounted to said elongated deck;
a wheel operably secured within said wheel block; and
a rear wheel truck assembly secured to an elevated rear section of the elongated deck, thereby allowing the skateboard to be balanced by said front wheel truck assembly and said wheel unless said skateboard is turned to the left or right.
